(19) United States
(12) Patent Application Publication
(10) Pub. No.: US 2025/0386266 A1
(43) Pub. Date: Dec. 18, 2025

(54) CELL RESELECTION MECHANISMS INTERWORKING

(71) Applicant: Nokia Technologies Oy, Espoo (FI)

(72) Inventors: Ugur Baran ELMALI, Munich (DE); Halit Murat GÜRSU, Munich (DE); Ahmad AWADA, Munich (DE); Muhammad NASEER-UL-ISLAM, Munich (DE); Ömer BULAKCI, Munich (DE); Philippe GODIN, Massy (FR); Jarkko Tuomo KOSKELA, Oulu (FI)

(21) Appl. No.: 18/878,443

(22) PCT Filed: Jul. 18, 2023
(86) PCT No.: PCT/FI2023/050444

§ 371 Date: Dec. 23, 2024

(30) Foreign Application Priority Data
Aug. 10, 2022 (FI) 20225711

(51) Int. Cl. H04W 36/08; H04W 48/18

(52) U.S. Cl. CPC H04W 36/08; H04W 48/18

(57) ABSTRACT

A network element of a wireless communication network is communicatively coupled to a user equipment and identifies a list of one or more features provided by the wireless communication network. Each feature on the list is related to at least one of a service capability of the UE and a service request of the user equipment. The network element determines a priority order among the one or more features related to cell reselection and assigns cell reselection priorities for the user equipment according to the priority order, for example by indicating cell reselection priorities or a priority order of features and corresponding cell reselection mechanisms to the user equipment. The user equipment performs cell reselection by applying a cell reselection mechanism and cell reselection priority in accordance with the indication of the network element.

### FIELD

The present disclosure generally relates to mobile communication networks such as a 5G communication network, and more particularly to cell reselection.

### BACKGROUND

Network slicing is a feature newly introduced by the 3^{rd} Generation Partnership Program (3GPP) in New Radio (NR) mobile networks, also referred to as the 5^{th} Generation (5G), to support different services using the same underlying mobile network infrastructure. The present state of standardization at a general level is given by 3GPP Technical Specification 38.300.

Network slices can differ either in their service requirements like Ultra-Reliable Low Latency Communication (URLLC) and enhanced Mobile Broadband (eMBB) or the tenant that provides those services.

A network slice is uniquely identified via a S-NSSAI (Single-Network Slice Selection Assistance Information). Current 3GPP specifications allow a User Equipment (UE) to be simultaneously connected and served by at most eight slices corresponding to eight network slices identified by eight S-NSSAIs, cf. 3GPP TS 38.300. On other hand, a cell may support tens or even hundreds of slices, e.g., in the current specifications a tracking area (TA) can have a support up to 1024 network slices, cf. 3GPP TS 38.423.

The present disclosure is directed to improve cell reselection in a network environment with network slicing and slice-specific cell reselection mechanisms.

### SUMMARY

According to a first aspect, a method for cell reselection is provided. The method is performed by a network element of a wireless communication network. The network element is communicatively coupled to a user equipment, UE. The network element identifies a list of one or more features provided by the wireless communication network. Each feature on the list is related to at least one of a service capability of the UE and a service request of the UE. The network element determines a priority order among the identified features related to cell reselection and assigns cell reselection priorities for the UE according to the priority order.

In some embodiments, assigning cell reselection priorities for the UE comprises indicating, to the UE, at least one of the cell reselection priorities and the priority order among the identified features related to cell reselection.

In some embodiments, assigning cell reselection priorities for the UE comprises determining, for each of the identified features, a Single-Network Slice Selection Assistance Information, S-NSSAI and a respective corresponding Network Slice Access Stratum Group, NSAG, for a slice-specific cell reselection mechanism, indicating, to the UE, cell reselection priorities corresponding to the determined priority order among the identified features related to cell reselection.

In some embodiments, a cell reselection priority is indicated in form of an NSAG priority or as a slice-specific cell reselection priority that is mapped to a corresponding NSAG.

In some embodiments, the network element sends, to the UE, Allowed Network Slice Selection Assistance Information, Allowed NSSAI, which comprises at least the one or more S-NSSAI(s) associated to the identified features.

In some embodiments, the network element sends, to the UE, Configured Network Slice Selection Assistance Information, Configured NSSAI, which comprises at least the one or more S-NSSAI(s) associated to the identified features.

In some embodiments, identifying the list of features comprises identifying the list of features based on a list of features of interest received from the UE.

In some embodiments, the features include at least one of slice specific cell reselection, Multicast Broadcast Services, High-Speed Data Networks specific and Sidelink communication.

In some embodiments, wherein the features related to cell reselection are features with a corresponding cell reselection mechanism.

In some embodiments, assigning cell reselection priorities for the UE comprises signaling, to the UE, the cell reselection priorities according to the priority order by way of system information broadcast or dedicated signaling.

According to a further aspect, a network element of a wireless communication network is provided. The network element is communicatively coupled to a user equipment, UE, and is arranged to identify a list of one or more features provided by the wireless communication network, wherein each feature on the list is related to at least one of a service capability of the UE and a service request of the UE, to determine a priority order among the identified features related to cell reselection, and to assign cell reselection priorities for the UE according to the priority order.

In some embodiments, the network element is arranged to assign cell reselection priorities for the UE by being caused to indicate, to the UE, at least one of the cell reselection priorities and the priority order among the identified features related to cell reselection.

In some embodiments, wherein the network element is arranged to determine, for each of the identified features, a Single-Network Slice Selection Assistance Information, S-NSSAI, and a respective corresponding Network Slice Access Stratum Group, NSAG, for a slice-specific cell reselection mechanism, and to indicate, to the UE, cell reselection priorities corresponding to the determined priority order among the identified features related to cell reselection.

In some embodiments, a cell reselection priority is indicated in form of an NSAG priority or as a slice-specific cell reselection priority that is mapped to a corresponding NSAG.

In some embodiments, the network element is arranged to send, to the UE, Allowed Network Slice Selection Assistance Information, Allowed NSSAI, comprising at least the one or more S-NSSAI(s) associated to the identified features.

In some embodiments, the network element is arranged to send, to the UE, Configured Network Slice Selection Assistance Information, Configured NSSAI, comprising at least the one or more S-NSSAI(s) associated to the identified features.

In some embodiments, the network element is arranged to identify the list of features based on a list of features of interest received from the UE.

In some embodiments, the features include at least one of slice specific cell reselection, Multicast Broadcast Services, High-Speed Data Networks specific and Sidelink communication.

In some embodiments, the features related to cell reselection are features with a corresponding cell reselection mechanism.

In some embodiments, the network element is arranged to assign cell reselection priorities for the UE by being caused to signal, to the UE, the cell reselection priorities according to the priority order by way of system information broadcast or dedicated signaling.

According to another aspect, a method for cell reselection is provided. The method is performed by a user equipment, UE, which is communicatively coupled to a network element of a wireless communication network. The UE receives, from the network element, at least one of cell reselection priorities for one or more features related to cell reselection and a priority order among the identified features related to cell reselection, wherein each of the features is provided by the wireless communication network and is related to at least one of a service capability of the UE and a service request of the UE. The UE applies a cell reselection mechanism of a plurality of cell reselection mechanisms, based on at least one of the cell reselection priorities and the priority order.

In some embodiments, wherein the features related to cell reselection are features with a corresponding cell reselection mechanism.

In some embodiments, receiving, from the network element, at least one of cell reselection priorities and a priority order comprises receiving the cell reselection priorities or the priority order by way of system information broadcast or dedicated signaling.

According to still a further aspect, a user equipment, UE, is provided which is communicatively coupled to a network element of a wireless communication network. The UE is arranged to receive, from the network element of the wireless communication network, at least one of cell reselection priorities for one or more features related to cell reselection and a priority order among the features related to cell reselection, wherein each of the features is provided by the wireless communication network and is related to at least one of a service capability of the UE and a service request of the UE. The UE is further arranged to apply a cell reselection mechanism of a plurality of cell reselection mechanisms, based on at least one of the cell reselection priorities and the priority order.

In some embodiments, the features related to cell reselection are features with a corresponding cell reselection mechanism.

In some embodiments, the UE is arranged to receive the at least one of cell reselection priorities and a priority order by being caused to receive the cell reselection priorities or the priority order by way of system information broadcast or dedicated signaling.

According to still another aspect, a method for cell reselection performed by a user equipment, UE, is provided. The UE is communicatively coupled to a network element of a wireless communication network. The UE receives, from the network element, cell reselection priorities corresponding to the determined priority order among one or more features related to cell reselection, wherein the cell reselection priorities include Network Slice Access Stratum Group, NSAG, priorities or slice-specific cell reselection priorities that are mapped to a respective corresponding NSAG, wherein each of the features is provided by the wireless communication network and is related to at least one of a service capability of the UE and a service request of the UE. The UE applies a slice-specific cell reselection mechanism based on the NSAG priorities or based on the slice-specific cell reselection priorities.

In some embodiments, the UE receives, from the network element, Allowed Network Slice Selection Assistance Information, Allowed NSSAI, which comprises at least one Single-Network Slice Selection Assistance Information, S-NSSAI, associated to the features for cell reselection.

In some embodiments, the UE receives, from the network element, Configured Network Slice Selection Assistance Information, Configured NSSAI, which comprises at least one Single-Network Slice Selection Assistance Information, S-NSSAI, associated to the features for cell reselection.

In some embodiments, the features include at least one of slice specific cell reselection, Multicast Broadcast Services, High-Speed Data Networks specific and Sidelink communication.

In some embodiments, the features related to cell reselection are features with a corresponding cell reselection mechanism.

In some embodiments, receiving, from the network element, cell reselection priorities comprises receiving the cell reselection priorities by way of system information broadcast or dedicated signaling.

According to still a further aspect, a user equipment, UE, is provided which is communicatively coupled to a network element of a wireless communication network. The UE is arranged to receive, from the network element, cell reselection priorities corresponding to the determined priority order among one or more features related to cell reselection, wherein the cell reselection priorities include Network Slice Access Stratum Group, NSAG, priorities or slice-specific cell reselection priorities that are mapped to a respective corresponding NSAG, wherein each of the features is provided by the wireless communication network and is related to at least one of a service capability of the UE and a service request of the UE. The UE is arranged to apply a slice-specific cell reselection mechanism based on the NSAG priorities or based on the slice-specific cell reselection priorities.

In some embodiments, the UE is arranged to receive, from the network element, Allowed Network Slice Selection Assistance Information, Allowed NSSAI, which comprises at least one Single-Network Slice Selection Assistance Information, S-NSSAI, associated to the features for cell reselection.

In some embodiments, the UE is arranged to receive, from the network element, Configured Network Slice Selection Assistance Information, Configured NSSAI, which comprises at least one Single-Network Slice Selection Assistance Information, S-NSSAI, associated to the features for cell reselection.

In some embodiments, the features include at least one of slice specific cell reselection, Multicast Broadcast Services, High-Speed Data Networks specific and Sidelink communication.

In some embodiments, the UE is arranged to receive cell reselection priorities by being caused to receive the cell reselection priorities by way of system information broadcast or dedicated signaling.

According to still a further aspect, a method for a slice-based cell reselection executed by a user device is presented. The user device is communicatively coupled to a network element of a wireless communication network. The user device receives at least one Network Slice Access Stratum Group, NSAG, and priority information of the at least one NSAG. The user device derives, based on the at least one NSAG and priority information of the at least one NSAG, a reselection priority of the slice-based cell reselection according to a predefined scheme (e.g., TS38.304 section 5.2.4.11). The user device does not modify the reselection priority due to other causes for cell reselection. That is, the user device applies the slice-based cell reselection mechanism even if one or more other causes for cell reselection than slice-based cell reselection trigger the cell reselection.

In some embodiments, the priority information of the at least one NSAG comprises at least one of a priority per NSAG and one or more priorities for corresponding one or more frequencies mapped to the at least one NSAG.

According to still a further aspect, a user device supporting a slice-based cell reselection, the user device is presented. The user device is communicatively coupled to a network element of a wireless communication network and comprising a processor and a memory with instructions which, when executed by the processor, cause the user device to receive at least one Network Slice Access Stratum Group, NSAG, and priority information of the at least one NSAG, to derive, based on the at least one NSAG and priority information of the at least one NSAG, a reselection priority of the slice-based cell reselection according to a predefined scheme, and not to modify the reselection priority due to other causes for cell reselection. That is, the user device applies the slice-based cell reselection mechanism even if one or more other causes for cell reselection than slice-based cell reselection trigger the cell reselection.

In some embodiments, the priority information of the at least one NSAG comprises at least one of a priority per NSAG and one or more priorities for corresponding one or more frequencies mapped to the at least one NSAG.

In accordance with still further aspects, a computer program comprises instructions which, when executed by at least one processor, implement the any one of the aforementioned method aspects and embodiments.

In accordance with still further aspects, a computer readable storage medium stores instructions which, when executed by at least one processor, cause a computer to execute any one of the aforementioned method aspects and embodiments.

### BRIEF DESCRIPTION OF THE FIGURES

In the following embodiments will be described in greater detail with reference to the attached drawings, in which:

FIG. 1 visualizes a slice-based cell reselection procedure.

FIG. 2 shows a schematic diagram of an example communication system comprising a base station and a plurality of communication devices.

FIG. 3 shows a schematic diagram of an example mobile communication device.

FIG. 4 shows a schematic diagram of an example control apparatus.

FIG. 5 is a flow-chart of a cell reselection procedure at a general level as described herein.

FIG. 6 is a general message sequence representation of a cell reselection procedure as described herein.

FIGS. 7A and 7B depict a slice-based cell reselection procedure on the basis of S-NSSAI and/or NSAG priorities relating to one or more features of the wireless communication network.

FIGS. 8A and 8B show a cell reselection procedure based on a priority order list of one or more features provided by the wireless communication network.

### DETAILED DESCRIPTION

As mentioned above, a network slice is identified by a S-NSSAI. The S-NSSAI may include both Slice Service Type (SST) and Slice Differentiator (SD) field with a total length of 32 bits or include only SST field part in which case the length of S-NSSAI is 8 bits, cf. 3GPP TS 23.501 and 3GPP TS 23.003. The SST field may have standardized and non-standardized values. Values 0 to 127 belong to the standardized SST range. For instance, SST value of 1 may indicate that the slice is suitable for handling of 5G eMBB, value 2 for handling of URLLC, etc. SD is operator-defined only.

TS 23.501 defines a number of types of an NSSAI: An allowed NSSAI is an NSSAI provided by the Serving PLMN during, e.g., a Registration procedure, indicating the S-NSSAI values the UE could use in the Serving PLMN for the current Registration Area. A configured NSSAI is provisioned in the UE applicable to one or more PLMNs. A pending NSSAI is provided by the Serving PLMN during a Registration procedure, indicating the S-NSSAI(s) for which the network slice-specific authentication and authorization procedure is pending. A requested NSSAI is provided by the UE to the Serving PLMN during registration. A subscribed S-NSSAI is based on subscriber information, which a UE is subscribed to use in a PLMN.

A UE in RRC IDLE or RRC INACTIVE state performs cell reselection identifying which cell the UE is to camp on. Cell reselection is based on radio measurements and frequency priorities, cf. 3GPP TS 38.304. The UE receives general frequency priorities in System Information such as System Information Blocks (SIBs) and may receive UE-specific priorities in an RRC Release message. The validity of the UE-specific priorities may be limited by a timer.

According to 3GPP TS 38.300, cell reselection criteria involve measurements of the serving and neighbor cells: Intra-frequency reselection is based on a ranking of cells. Inter-frequency reselection is based on absolute priorities where a UE tries to camp on the highest priority frequency available. An NCL (Neighbor Cell List) can be provided by the serving cell to handle specific cases for intra- and inter-frequency neighboring cells. Excluded-lists can be provided to prevent the UE from reselecting to specific intra- and inter-frequency neighboring cells. Allowed-lists can be provided to request the UE to reselect to only specific intra- and inter-frequency neighboring cells. Cell reselection can be speed dependent. Service specific prioritization is possible.

Until 3GPP specifications Release 17, cell reselection was network slice agnostic. However, the most appropriate cell to be selected by a UE may depend on the slices the UE intends to use. Thus, in Release 17, a functionality of slice-based cell reselection is introduced. Hence, slice-specific cell reselection information can be provided to facilitate the UE to reselect a cell that supports specific slices. This slice-specific cell reselection mechanism is based on slice-specific cell reselection priorities and enables the UE to reselect a cell on a frequency that is preferred by the network operator based on the most important network slice(s) for the UE, although it is not guaranteed that the UE reselects a cell that supports the allowed network slices or the most important network slices. If a UE reselects a cell that does not support the allowed network slices, then the network can still redirect or handover the UE (in RRC CONNECTED state) to a cell that is more suitable for the UE (e.g., in terms of network slices).

In addition, the concept of slice groups (NSAG—Network Slice AS Group) is introduced to enable signaling optimization (especially for broadcast) and to promote security when advertising S-NSSAIs. The UE receives a mapping of the slices to the NSAGs using Non-Access stratum (NAS) signaling. The UE may also receive a priority per NSAG (NSAG-specific cell reselection priorities). Broadcasting of priority information for slice-specific cell reselection (e.g., slice-specific reselection priorities) are performed per NSAG (nsag-CellReselectionPriority, cf. 3GPP TS 38.304, subclause 5.2.4.1 and 5.2.4.11) by the Radio Access Network (RAN) node such as a gNB.

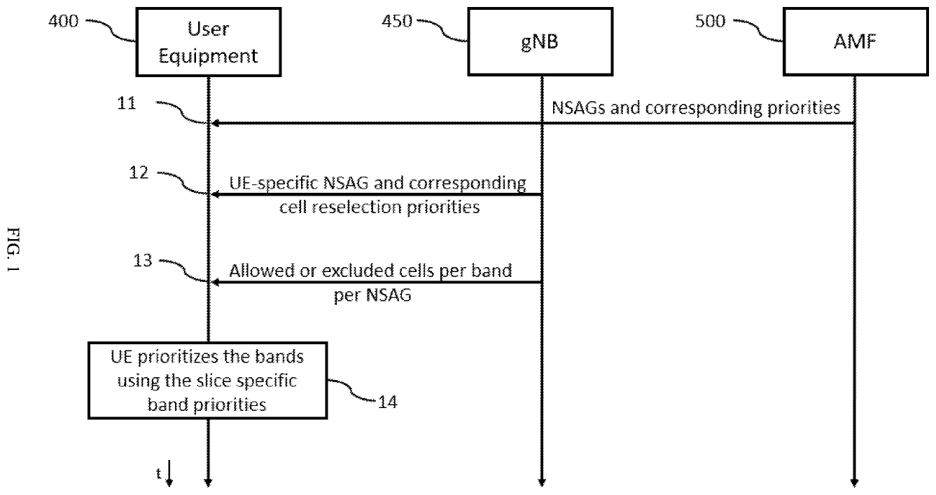

An exemplary slice-specific cell reselection procedure is shown by FIG. 1. The UE 400 receives, at 11, general NSAGs and corresponding priorities (which are different from cell reselection priorities) from the network such as the AMF 500 by way of a NAS message. At 12, the UE 400 receives NSAG-specific cell reselection priorities (frequency band priorities per NSAG) from RAN (e.g. gNB 450) either by way of broadcast (a new SIB may be defined for this purpose) or by way of dedicated signaling such as an RRC Release message transitioning the UE 400 e.g. from RRC CONNECTED to RRC IDLE. Cell reselection information received in dedicated signaling such as an RRC Release message has a precedence over reselection information in SIB(s). The gNB 450 managing a cell may broadcast, at 13, either a list of allowed or a list of excluded cells per band per NSAG to support the cell reselection at the border areas of Tracking Areas. A cell that is in the allowed list or not in the excluded list is assumed to support the given NSAG, provided that a list is present for the given NSAG and band. The UE 400 prioritizes, at 14, frequency bands using the NSAG-specific cell reselection priorities (cf. TS 38.304 for further details on how the UE uses the priorities), and, consequently, remains to camp on the current serving cell or reselects to another cell, also taking into account the cell reselection criteria set forth above.

In other Release-17 Work Items, other cell reselection mechanisms are defined, cf. TS 38.304, also referred to feature-specific cell reselection mechanisms hereinafter. One of these further cell reselection mechanisms relates to High-speed Data Networks (HSDN). When an HSDN-capable UE is in a high-mobility state, the UE shall consider the HSDN cells to be the highest priority (i.e., higher than any other network configured priorities). When the HSDN-capable UE is not in high-mobility state, the UE shall always consider HSDN cells to be the lowest priority (i.e., lower than any other network configured priorities).

A further cell reselection mechanism relates to Multicast Broadcast Services (MBS). If the MBS-capable UE receives or is interested to receive an MBS session and can receive this MBS session by camping on a frequency on which the MBS session is provided, the UE may consider that particular frequency to be the highest priority during the MBS session as specified in TS 38.300. As long as the MBS-capable UE is receiving or interested to receive an MBS session, the UE may consider cell reselection candidate frequencies at which the UE is unable to receive the MBS session to be of the lowest priority during the MBS broadcast session (cf. TS 38.300).

Still a further cell reselection mechanism relates to Sidelink communication from pre-Release-17. If the UE is configured to perform both NR Sidelink communication and V2X (Vehicle to Everything) Sidelink communication, the UE may consider the frequency providing both NR Sidelink communication configuration and V2X Sidelink communication configuration to be the highest priority. If the UE is configured to perform NR Sidelink communication and not perform V2X communication, the UE may consider the frequency providing NR Sidelink communication configuration to be the highest priority. If the UE is configured to perform V2X Sidelink communication and not perform NR Sidelink communication, the UE may consider the frequency providing V2X Sidelink communication configuration to be the highest priority.

Currently, there are no measures for the UE to determine which slice provides a broadcast session—even not included in User Service Description (USD) of an MBS session—as broadcast services can be received by all authorized UEs in a geographical area. Note that this is different from multicast services, where the UE needs to join a multicast session and therefore, receives the relevant S-NSSAI in the USD. For that reason, currently, the UE does not need to be configured in Allowed NSSAI with the S-NSSAI that the UE would use for broadcast services.

In case of slice-specific cell reselection, the UE shall derive frequency reselection priorities based on NSAG and their corresponding cell reselection priorities. MBS allows the UE to consider MBS frequencies as highest priority to enhance broadcast service continuity. Similarly, HSDN allows UE to consider some frequencies as highest priority. This also holds for Sidelink communication.

Thus, the UE behavior is currently unspecific when the UE intends to use, e.g., slice-specific cell reselection in addition to a feature-specific cell reselection mechanism such as MBS frequency prioritization. More specifically, the meaning of e.g. MBS frequency being “considered as highest priority” could be attributed with several possible interpretations. For example, does MBS override slice-specific priorities or work in addition to those? Is MBS frequency considered as highest-priority frequency among frequencies that are not mapped to any slice-specific priority (i.e., frequencies with slice-specific priorities always have higher priority than MBS)? Is MBS frequency considered as highest-priority frequency (i.e., overrides even frequencies with slice-specific priorities)? Is MBS considered highest-priority frequency among those slices that allow MBS frequency and within those slices NSAG specific priorities are used to select the best frequency to camp on?

Hence, the objective of the present disclosure is to provide for an interworking between different cell reselection mechanisms available in Release-17 and potentially future cell reselection mechanisms.

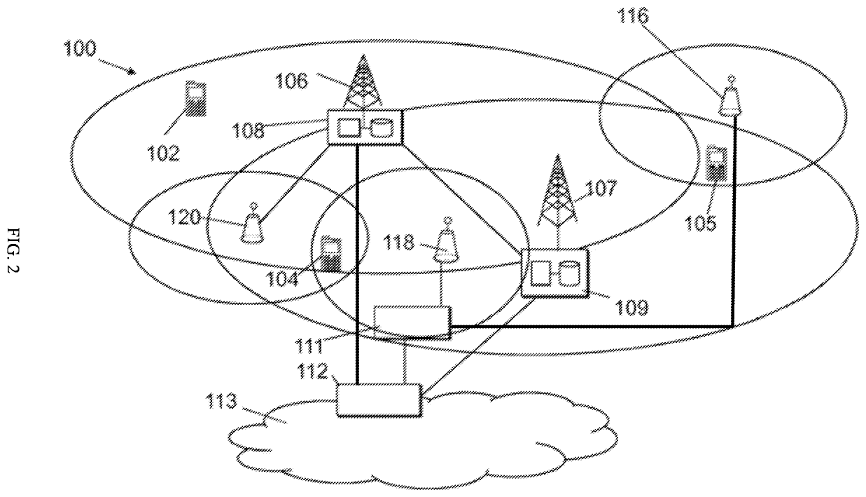

Before explaining the examples in detail, certain general principles of a wireless communication system and mobile communication devices are briefly explained with reference to FIGS. 2 to 4 to assist in understanding the technology underlying the described examples.

In a wireless communication system 100, such as that shown in FIG. 2, mobile communication devices, user devices, User Equipment (UE) 102, 104, 105 are provided wireless access via at least one base station (e.g., next generation NB, gNB), similar wireless transmitting and/or receiving node or network node. Base stations may be controlled or assisted by at least one appropriate controller apparatus, so as to enable operation thereof and management of mobile communication devices in communication with the base stations. The controller apparatus may be located in a Radio Access Network (RAN) (e.g., wireless communication system 100) or in a Core Network (CN) (not shown) and may be implemented as one central apparatus or its functionality may be distributed over several apparatuses. The controller apparatus may be part of the base station and/or provided by a separate entity such as a Radio Network Controller (RNC) or central unit (CU), typically implementing higher network layers such as layer 3 protocols and/or a Radio Resource Control (RRC) protocol. In FIG. 2, control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in the RNC.

In FIG. 2, base stations 106 and 107 are shown as connected to a wider communications network 113 via gateway 112. A further gateway function may be provided to connect to another network.

As used herein, the term “base station” has the full breadth of its ordinary meaning, and at least includes a wireless communication station installed at a fixed location and used to communicate as part of a wireless telephone system or radio system. The communication area (or coverage area) of the base stations may be referred to as a “cell.” The base stations and the UEs may be configured to communicate over the transmission medium using any of various Radio Access Technologies (RATs), also referred to as wireless communication technologies, or telecommunication standards described hereinbelow. As illustrated in FIG. 2, while one of the base stations may act as a “serving cell” for UEs, an UE may also be capable of receiving signals from (and possibly within communication range of) one or more other cells (which might be provided by the base stations and/or any other base stations), which may be referred to as “neighboring cells”. As mentioned above, a base station may include multiple network nodes such as a superordinated controller node implementing higher network layers such as layer 3/RRC and one or more subordinated nodes such as distributed units (DUs) typically implementing lower network layers such as the physical layer (layer 1, L1) and layer 2 (L2). Note that these multiple units may be geographically co-located or geographically dislocated to a certain extent.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example, Wireless Local Area Network (WLAN) and may be WLAN Access Points (APs). The communication devices 102, 104, 105 may access the communication system based on various access techniques, such as Code Division Multiple Access (CDMA), or Wideband CDMA (WCDMA). Other non-limiting examples comprise Time Division Multiple Access (TDMA), Frequency Division Multiple Access (FDMA) and various schemes thereof such as the Interleaved Frequency Division Multiple Access (IFDMA), Single Carrier Frequency Division Multiple Access (SC-FDMA) and Orthogonal Frequency Division Multiple Access (OFDMA), Space Division Multiple Access (SDMA) and so on.

An example of wireless communication systems are architectures standardized by the 3rd Generation Partnership Project (3GPP). A latest 3GPP based development is often referred to as the Long-Term Evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (or LTE-A) employs a radio mobile architecture known as the Evolved Universal Terrestrial Radio Access Network (E-UTRAN) and a Core Network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations for the communication devices. Other examples of radio access system comprise those provided by base stations of systems that are based on technologies such as WLAN and/or Worldwide interoperability for Microwave access (WiMax). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QOS) support, and some on-demand requirements for QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilize Network Functions Virtualization (NFV) which is a network architecture concept that proposes virtualizing network node functions into “building blocks” or entities that may be operationally connected or linked together to provide services. A Virtualized Network Function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

An example 5G Core Network (CN) comprises functional entities. The CN is connected to a UE via the Radio Access Network (RAN). A User Plane Function (UPF) whose role is called PDU Session Anchor (PSA) may be responsible for forwarding frames back and forth between the Data Network (DN) and the tunnels established over the 5G for the UEs exchanging traffic with the DN.

The UPF is controlled by a Session Management Function (SMF) that receives policies from a Policy Control Function (PCF). The CN may also include an Access and Mobility Function (AMF).

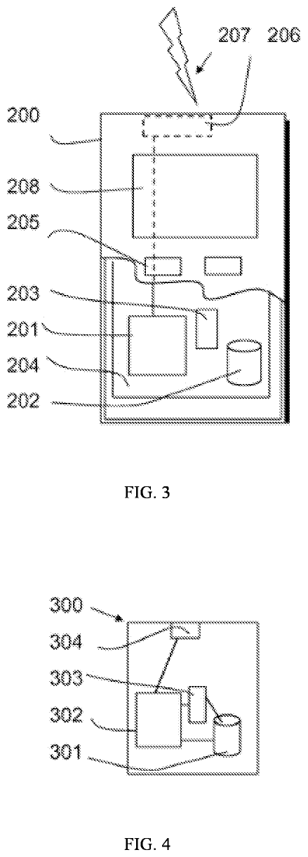

A possible (mobile) communication device 200 will now be described in more detail with reference to FIG. 3 showing a schematic, partially sectioned view. Such a mobile communication device 200 is often referred to as User Equipment (UE), user device or terminal device. An appropriate mobile communication device 200 may be provided by any device capable of sending and receiving radio signals. Non-limiting examples comprise a Mobile Station (MS) or mobile device such as a mobile phone or what is known as a smart phone, a computer provided with a wireless interface card or other wireless interface facility (e.g., USB dongle), Personal Data Assistant (PDA) or a tablet provided with wireless communication capabilities, or any combinations of these or the like. The communication device 200 may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

In an industrial application a communication device may be a modem integrated into an industrial actuator (e.g., a robot arm) and/or a modem acting as an Ethernet-hub that will act as a connection point for one or several connected Ethernet devices (which connection may be wired or unwired).

The communication device 200 is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets 204. The user may control the operation of the communication device 200 by means of a suitable user interface such as keypad 205, voice commands, touch sensitive screen or pad, combinations thereof or the like. A display 208, a speaker and a microphone can be also provided. Furthermore, the communication device 200 may comprise appropriate connectors (either wired or wireless) to other devices and/or for connecting external accessories, for example hands-free equipment, thereto.

The communication device 200 may receive signals over an air or radio interface 207 via appropriate apparatus for receiving and may transmit signals via appropriate apparatus for transmitting radio signals. In FIG. 3, transceiver apparatus is designated schematically by block 206. The transceiver apparatus 206 may be provided for example by means of a radio part and associated antenna arrangement. The antenna arrangement may be arranged internally or externally to the communication device 200.

The communication device 200 may also or alternatively be configured to communicate using one or more Global Navigational Satellite Systems (GNSS such as GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Generally, the communication device 200 illustrated in FIG. 3 includes a set of components configured to perform core functions. For example, this set of components may be implemented as a system on chip (SoC), which may include portions for various purposes. Alternatively, this set of components may be implemented as separate components or groups of components for the various purposes. The set of components may be (communicatively) coupled (e.g., directly or indirectly) to various other circuits of the communication device 200.

The communication device 200 may include at least one antenna in communication with a transmitter and a receiver (e.g., the transceiver apparatus 206). Alternatively, transmit and receive antennas may be separate. The communication device 200 may also include a processor (e.g., the at least one data processing entity 201) configured to provide signals to and receive signals from the transmitter and receiver, respectively, and to control the functioning of the communication device 200. The processor may be configured to control the functioning of the transmitter and receiver by effecting control signaling via electrical leads to the transmitter and receiver. Likewise, the processor may be configured to control other elements of the communication device 200 by effecting control signaling via electrical leads connecting processor to the other elements, such as a display (e.g., display 208) or a memory (e.g., the at least one memory 202). The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an Application Specific Integrated Circuit (ASIC), a Field Programmable Gate Array (FPGA), and/or the like, or some combination thereof. Accordingly, in some examples, the processor may comprise a plurality of processors or processing cores.

The communication device 200 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, WLAN techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the communication device 200 and/or a cellular modem therein may be capable of operating in accordance with various 3rd Generation (3G) communication protocols, 4th generation (4G) communication protocols, 5^{th} Generation (5G) communication protocols, Internet Protocol Multimedia Subsystem (IMS) communication protocols such as, for example, Session Initiation Protocol (SIP) and/or the like, or 5G beyond. For example, the communication device 200 may be capable of operating in accordance with 4G wireless communication protocols, such as LTE-A, 5G, and/or the like as well as similar wireless communication protocols that may be subsequently developed.

It is understood that the processor may include circuitry for implementing audio/video and logic functions of the communication device 200. For example, the processor may comprise a digital signal processor device, a microprocessor device, an analog-to-digital converter, a digital-to-analog converter, and/or the like. Control and signal processing functions of the communication device 200 may be allocated between these devices according to their respective capabilities. The processor may additionally comprise an internal voice coder, an internal data modem, and/or the like. Further, the processor may include functionality to operate one or more software programs, which may be stored in memory. In general, the processor and stored software instructions may be configured to cause the communication device 200 to perform actions. For example, the processor may be capable of operating a connectivity program, such as a web browser. The connectivity program may allow the communication device 200 to transmit and receive web content, such as location-based content, according to a protocol, such as Wireless Application Protocol (WAP), HyperText Transfer Protocol (HTTP), and/or the like.

The communication device 200 may also comprise a user interface including, for example, an earphone or speaker, a ringer, a microphone, a display, a user input interface, and/or the like, which may be operationally coupled to the processor. The display may, as noted above, include a touch sensitive display, where a user may touch and/or gesture to make selections, enter values, and/or the like. The processor may also include user interface circuitry configured to control at least some functions of one or more elements of the user interface, such as the speaker, the ringer, the microphone, the display, and/or the like. The processor and/or user interface circuitry comprising the processor may be configured to control one or more functions of one or more elements of the user interface through computer program instructions, for example, software and/or firmware, stored on a memory accessible to the processor, for example, volatile memory, non-volatile memory, and/or the like. The communication device 200 may include a battery for powering various circuits related to the mobile terminal, for example, a circuit to provide mechanical vibration as a detectable output. The user input interface may comprise devices allowing the communication device 200 to receive data, such as a keypad (e.g., keypad 206) and/or other input devices. The keypad can also be a virtual keyboard presented on display or an externally coupled keyboard.

The communication device 200 may also include one or more mechanisms for sharing and/or obtaining data. For example, the communication device 200 may include a short-range radio frequency (RF) transceiver and/or interrogator, so data may be shared with and/or obtained from electronic devices in accordance with RF techniques. The communication device 200 may include other short-range transceivers, such as an infrared (IR) transceiver, a Bluetooth™ (BT) transceiver operating using Bluetooth™ wireless technology, a wireless Universal Serial Bus (USB) transceiver, a Bluetooth™ Low Energy transceiver, a ZigBee transceiver, an ANT transceiver, a cellular device-to-device transceiver, a wireless local area link transceiver, and/or any other short-range radio technology. The communication device 200 and more specifically, the short-range transceiver may be capable of transmitting data to and/or receiving data from electronic devices within the proximity of the apparatus, such as within 10 meters, for example. The communication device 200 including the Wi-Fi or WLAN modem may also be capable of transmitting and/or receiving data from electronic devices according to various wireless networking techniques, including 6LoWPAN, Wi-Fi, Wi-Fi low power, WLAN techniques such as IEEE 802.11 techniques, IEEE 802.15 techniques, IEEE 802.16 techniques, and/or the like.

The communication device 200 may comprise memory, such as one or more Subscriber Identity Modules (SIM), one or more Universal Subscriber Identity Modules (USIM), one or more removable User Identity Modules (R-UIM), one or more Embedded Universal Integrated Circuit Cards (eUICCs), one or more Universal Integrated Circuit Cards (UICC), and/or the like, which may store information elements related to a mobile subscriber. In addition, the communication device 200 may include other removable and/or fixed memory. The communication device 200 may include volatile memory and/or non-volatile memory. For example, the volatile memory may include Random Access Memory (RAM) including dynamic and/or static RAM, on-chip or off-chip cache memory, and/or the like. The non-volatile memory, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory, the non-volatile memory may include a cache area for temporary storage of data. At least part of the volatile and/or non-volatile memory may be embedded in the processor. The memories may store one or more software programs, instructions, pieces of information, data, and/or the like which may be used by the apparatus for performing operations disclosed herein.

The memories may comprise an identifier, such as an International Mobile Equipment Identification (IMEI) code, capable of uniquely identifying the communication device 200. In the example embodiment, the processor may be configured using computer code stored at memory to cause the processor to perform operations disclosed herein.

Some of the embodiments disclosed herein may be implemented in software, hardware, application logic, or a combination of software, hardware, and application logic. The software, application logic, and/or hardware may reside on the memory, the processor, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 3, computer-readable medium may comprise a non-transitory computer-readable storage medium that may be any media that can contain or store the instructions for use by or in connection with an instruction execution system, apparatus, or device, such as a computer.

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio for a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021-06) sections 42.1 and 4.4, incorporated by reference). A UE is e.g. either in RRC_CONNECTED state or in RRC_INACTIVE state when an RRC connection has been established.

In RRC_CONNECTED state a UE may store the AS (access stratum) context, transfer unicast data to/from the UE, monitor control channels associated with the shared data channel to determine if data is scheduled for the data channel, provide channel quality and feedback information, perform neighboring cell measurements and measurement reporting.

In some embodiments, the communication device 200 (i.e., UE or a user device in a network) comprises the processor (e.g., the at least one data processing entity 201) and the memory (e.g., the at least one memory 202). The memory includes computer program code causing the communication device 200 to perform processing according to the methods described below.

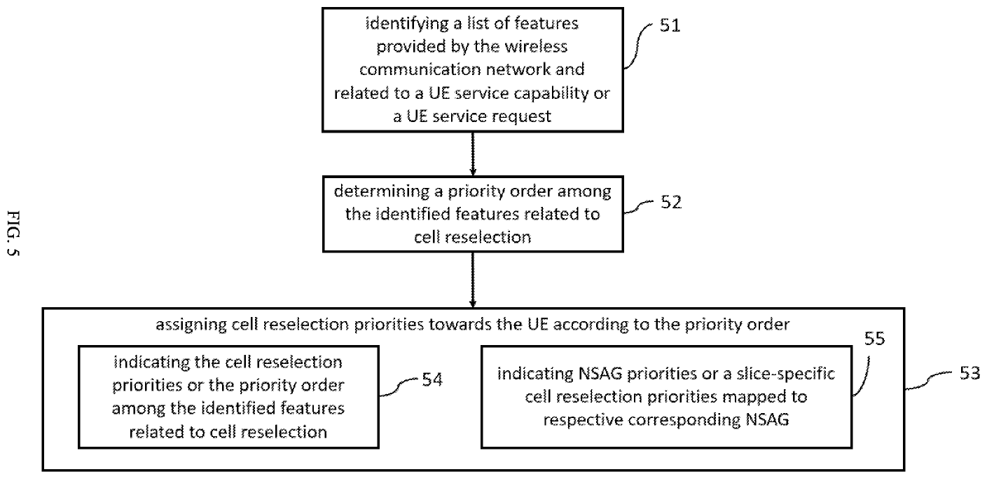

FIG. 4 shows an example embodiment of a control apparatus for a communication system, for example to be coupled to and/or for controlling a station of an access system, such as a RAN node, e.g., a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as an RNC or a spectrum controller. In some embodiments, an base station may have such a control apparatus as well as a control apparatus being provided in an RNC. The control apparatus 300 can be arranged to provide control on communications in the service area of the system. The control apparatus 300 comprises at least one memory 301, at least one data processing unit 302, 303 and an input/output interface 304. Via the interface the control apparatus 300 can be coupled to a receiver and a transmitter of the base station. The receiver and/or the transmitter may be implemented as a radio front end or a remote radio head.

Generally, the control apparatus 300 has an antenna, which transmits and receives radio signals. A radio frequency (RF) transceiver module, coupled with the antenna, receives RF signals from antenna, converts them to baseband signals and sends them to processor (e.g., the at least one data processing unit 302, 303). RF transceiver also converts received baseband signals from processor, converts them to RF signals, and sends out to antenna. A processor processes the received baseband signals and invokes different functional modules to perform features in control apparatus 300. Memory (e.g., the at least one memory 301) stores program instructions and data to control the operations of the control apparatus 300. In the example of FIG. 4, the control apparatus 300 also includes protocol stack and a set of control functional modules and circuit. PDU session handling circuit handles PDU session establishment and modification procedures. Policy control module that configures policy rules for UEs. Configuration and control circuit provides different parameters to configure and control UEs of related functionalities including mobility management and session management. Suitable processors include, by way of example, a special purpose processor, a digital signal processor (DSP), a plurality of micro-processors, one or more microprocessor associated with a DSP core, a controller, a microcontroller, ASICs, FPGA circuits, and other type of integrated circuits (ICs), and/or state machines.

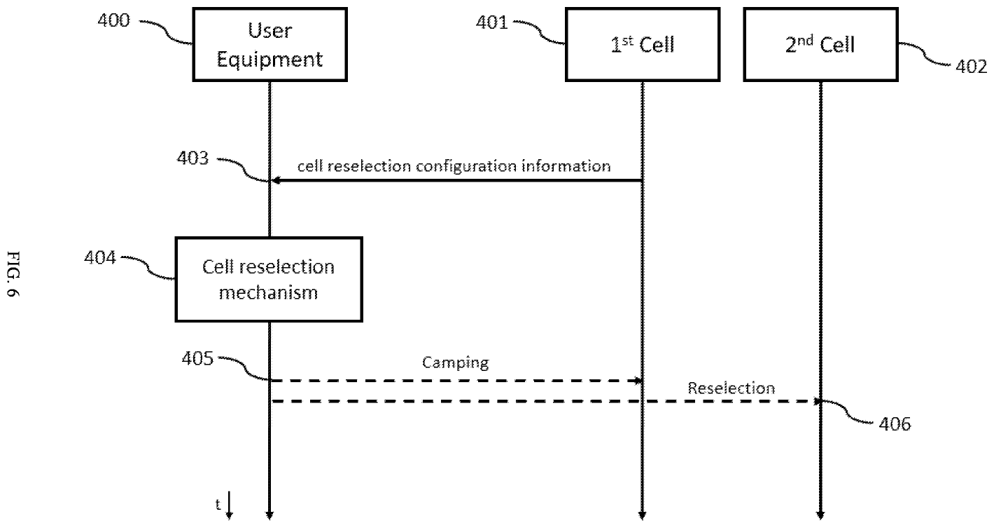

In some embodiments, the control apparatus 300 (i.e., a base station, a wireless transmitting and/or receiving point equipment, or a network node in a network) comprises the processor (e.g., the at least one data processing unit 302, 303) and the memory (e.g., the at least one memory 301). The memory includes computer program code causing the control apparatus 300 to perform processing according to the method described below with reference to FIG. 5 et seq.

Now turning to FIG. 5, method and network element for cell reselection is visualized at a general level. The network element forms a part of a wireless communication network and may include multiple sub-components such as one or more RAN nodes and/or one or more core network nodes. The network element is communicatively coupled to a user equipment, UE, the cell reselection procedure of which is to be controlled by the present functionality. The network element may be a base station (e.g., gNB). The network element identifies, at 51, a list of one or more features provided by the wireless communication network, wherein each feature on the list is related to at least one of a service capability of the UE and a service request of the UE. A feature may be a service supported and provided by the wireless network on specific network slices such as MBS, HSDN, Sidelink, as further explained below. A feature may also be slice-specific cell reselection. In embodiments, the network element determines such features to be included in the list for which a corresponding cell reselection mechanism is defined in the wireless communication network and for which the UE has signaled interest and/or has capability. For example, if the feature of network slicing is not supported by the UE and the UE may have signaled this by way of an earlier capability negotiation, the network element may determine that network slicing is not to be included in the list of features. On the other hand, if the UE has registered and/or signaled interest for an MBS session, the network element includes MBS on the list of one or more features for cell reselection. The network element then, at 52, determines a priority order among the identified features related to cell reselection. Hence, accordingly, each of the identified features corresponds to a cell reselection mechanism, e.g. the feature MBS corresponds to MBS specific cell reselection as introduced above. Prioritization of a feature thus constitutes a prioritization of the associated or related cell reselection.

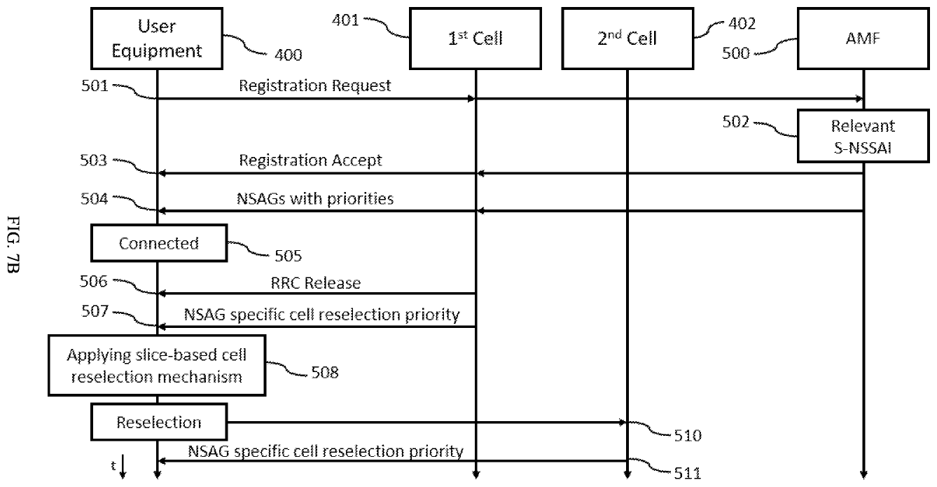

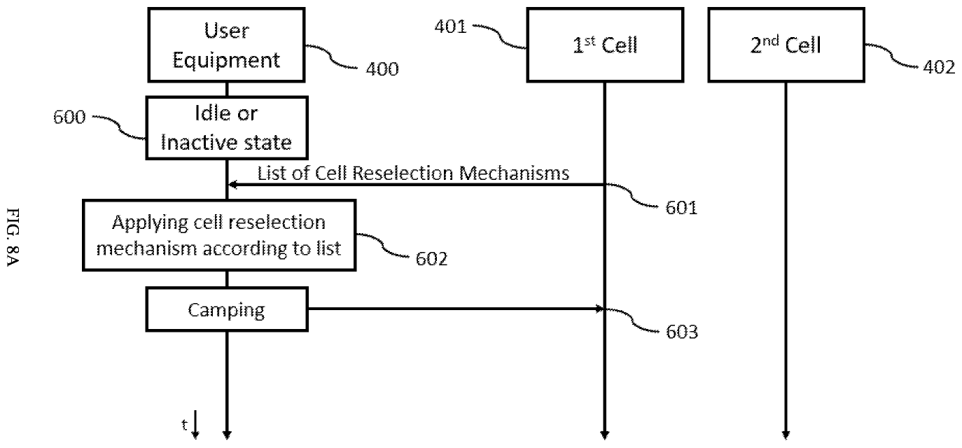

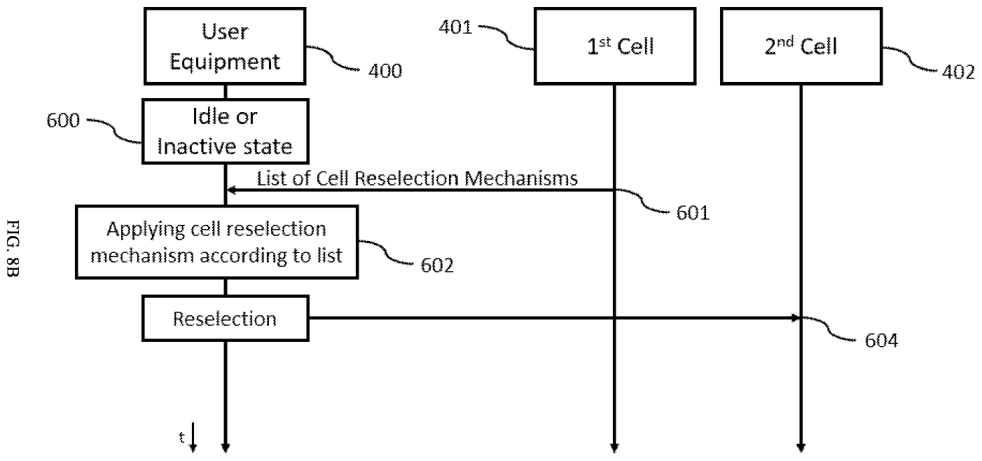

The network element then, at 53, assigns cell reselection priorities for the UE based on the priority order. The assigning activity or functionality 53 may include multiple sub-activities or sub-functionalities involving transmissions or signaling to the UE. In some variants, the network element indicates, at 54, to the UE, at least one of the cell reselection priorities and the priority order among the identified features related to cell reselection. As explained in more detail further below, the priority order among the listed features relates to cell reselection or, in other words, the priority order among the cell reselection mechanisms corresponding to the identified and prioritized features can be indicated in form of a sorted lists in which first-mentioned features have been determined to be of higher priority than later-mentioned features. Particular examples are given further below with reference to FIGS. 7A and 7B, as well as FIGS. 8A and 8B.

In some variants, the network element determines, for each of the identified features, a Single-Network Slice Selection Assistance Information, S-NSSAI and a respective corresponding Network Slice Access stratum Group, NSAG, for a slice-specific cell reselection mechanism. The network element then indicates, at 55, to the UE, cell reselection priorities corresponding to the determined priority order among the identified features related to cell reselection. The cell reselection priorities may indicate priorities of radio frequencies which are mapped to NSAGs and which may prescribe priorities to the UE for selecting the available cells in a cell reselection procedure. More specifically, at 55, the network element indicates a cell reselection priority in form of an NSAG priority or as a slice-specific cell reselection priority for a frequency that is mapped to a corresponding NSAG. The network element may also send Allowed NSSAI or Configured NSSAI with at least the one or more of the determined S-NSSAI(s) associated to the identified features. Generally, the information indicated to the UE by the network element to control the cell reselection behavior of the UE may also be denoted as cell reselection configuration information hereinafter.

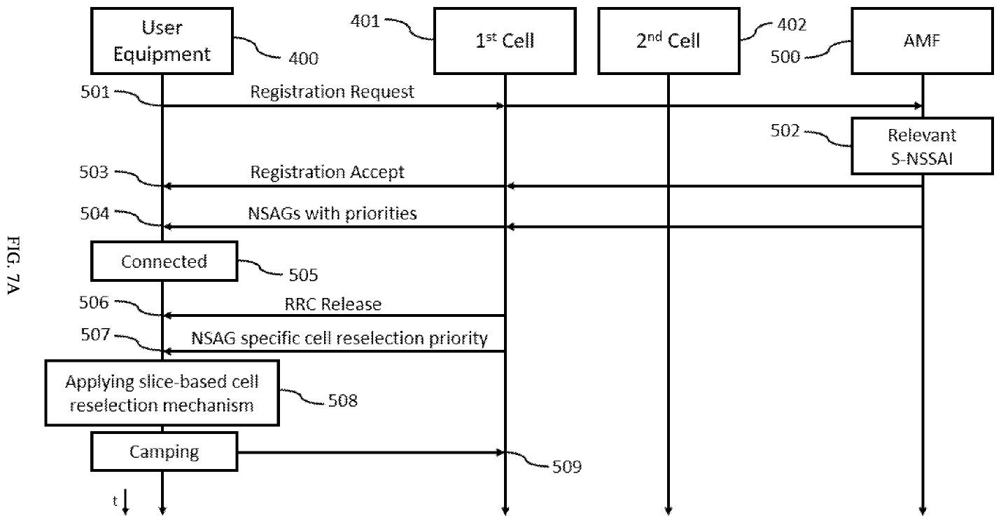

FIG. 6 is a further presentation of a cell reselection procedure in accordance with the present methodologies. The method may be performed by a UE 400 which is communicatively coupled i.e., in active, inactive, or idle state, to a first cell 401 of a wireless communication network. From another perspective, the method is likewise performed by one or more network elements of the wireless communication network. The network side, i.e. a network element of the wireless communication network such as a gNB (more specifically, e.g. a node of the gNB such as the central unit, CU) sends cell reselection configuration information to the UE 400. The UE 400, currently located in, being connected to or camping on the first cell 401 provided by the network element receives, at 403, the cell reselection configuration information from the network element of the wireless communication network.

The cell reselection configuration information includes, potentially among others, network slice selection assistance information, NSSAI, related to one or more features such as a service capability of the UE and/or a service provided by the wireless communication network, and/or is indicative of priorities of a plurality of cell reselection mechanisms corresponding to the features. The cell reselection configuration information may include various information which controls and prioritizes the cell reselection behavior of the UE 400. In order to control the UE 400 to apply slice specific cell reselection, the cell reselection information includes Network Slice Selection Assistance Information (NSSAI). In order to control the UE 400 to apply a cell reselection mechanism out of a plurality of cell reselection mechanisms corresponding to services or features provided by network slices of the wireless communication network, such as Multicast Broadcast Services (MBS), High-Speed Data Networks (HSDN) and/or Sidelink communications, the cell reselection configuration information may be indicative of priorities of any one of the one or more features and the corresponding cell reselection mechanisms. Both options, NSSAI and prioritization of cell reselection mechanisms control the UE to use e.g. slice-specific cell reselection mechanism, even though the UE also receives MBS/HSDN/Sidelink transmissions and could therefore also apply a cell reselection mechanism corresponding to such transmissions.

Before signaling the cell reselection priorities to the UE 400, the network element identifies features to be considered for the prioritization, as already mentioned above. For example, the UE 400 may have indicated earlier capabilities and/or service interests to the network, such as a support of MBS, etc. Thus, the UE 400 may have been sent list of features of interest to the network element beforehand to facilitate identification and prioritization of features and corresponding cell reselection mechanisms. The network element may then identify slice specific cell reselection and MBS as the features to be prioritized, and determines priorities of and/or a priority order between these two features. Based on the priorities and/or priority order, the UE 400 is instructed to apply one of the cell reselection mechanisms such as slice specific cell reselection, but not MBS specific cell reselection, and reselects to a cell based on the cell reselection priorities assigned or provided by the network element.

Thus, in embodiments, the cell reselection configuration information may include further information, such as cell reselection priorities, including frequency prioritization related information, e.g. a list of frequency-mapped NSAGs and corresponding cell reselection priorities for the frequencies, lists such as allowed lists, excluded lists, neighbor cell lists, service specific prioritization information, and the like. In some embodiments, a mapping between NSAGs and frequencies are provided together with corresponding cell reselection priorities for the frequencies, while in other embodiments, the NSAG-to-frequency mapping is provided on top of feature-relevant S-NSSAI(s) as Allowed or Configured NSSAI, but the cell reselection configuration information does not include any priorities for the frequencies mapped to the NSAGs. In such embodiments, the UE 400 is enabled reselect to a cell by way of slice specific cell reselection based on NSAG-specific priorities and the feature-relevant S-NSSAI(s) provided as Allowed or Configured NSSAI.

Generally, the cell reselection configuration information such as the cell reselection priorities or the priority order among the features/cell reselection mechanisms may be transmitted in a single message but may be distributed over multiple messages. These messages may include NAS and AS/RAN messages. For example, a part of the cell reselection configuration information may be sent by the core network by way of one or more NAS messages, while another part of the cell reselection configuration information is sent by one or more network elements of the radio access network of the wireless communication network. The cell reselection information may be broadcast to all UEs in the cell 401, and/or may be transmitted by way of dedicated signaling, e.g. by way of RRC messages such as RRC Release messages transitioning a UE from RRC CONNECTED to e.g. RRC IDLE state. Accordingly, the cell reselection information may be transmitted periodically or on demand, e.g. in response to a request of the UE. Parts of the cell reselection information may be transmitted in the course of particular procedures specified by 3GPP Technical Specifications, such as a Registration procedure comprising a Registration request with Requested NSSAI(s) and a Registration response with Allowed NSSAI (indicating S-NSSAI(s) corresponding the features requested or supported by the UE) or Configured NSSAI (indicating S-NSSAI(s) corresponding the features requested or supported by the UE). The cell reselection information provided to the UE 400 may reflect UE capabilities and demands, such as a capability or interest to consume a feature such as to receive an MBS transmission.

After having received the cell reselection configuration information indicating cell reselection priorities, at 404, the UE 400 applies a cell reselection mechanism of the plurality of cell reselection mechanisms, namely based on the NSSAI or the priorities of the plurality of cell reselection mechanisms as conveyed by the cell reselection configuration information. Hence, the UE 400 decides, based on the given cell reselection configuration information and potentially own capabilities and current service demands, which cell reselection mechanism out of multiple cell reselection mechanisms is to be applied in order to decide to camp 405 on the present first cell 401 or to reselect 406 to another second cell 402. Note that, second cell 402 may belong to the same gNB or CU controlling the first cell 401 or to the another gNB controlling first cell 401.

Thus, by determining slice-specific cell reselection priorities which prioritize features supported by the wireless communication and which are relevant to the UE, the UE is enabled to perform cell reselection also to consume a feature such as MBS by using the slice-based cell reselection mechanism as opposed to using the cell reselection mechanism specific for the particular feature. In other words, when the UE is in camped normally state, if the UE supports slice-based cell reselection and has received NSAG(s) and their priorities from NAS, the UE shall derive re-selection priorities according to TS 38.304 clause 5.2.4.11 and will not modify reselection priorities due to other causes (e.g. MBS frequency prioritization). That is, the user device applies the slice-based cell reselection mechanism even if one or more other causes for cell reselection than slice-based cell reselection trigger the cell reselection. In this respect, as explained above, it is up to the network to ensure prioritization of services (e.g. MBS) when NSAG priorities are used.

FIGS. 7A and 7B visualize more specific variants of cell reselection according to methodologies described herein. More specifically, FIGS. 7A and 7B relate to variants in which the network element provides one or more NSSAIs which indicate one or more cells which provide for Multicast Broadcast Services transmissions, High-Speed Data Networks transmission or Sidelink communications. This controls the UE to utilize slice-specific cell reselection instead of applying a service or feature related cell reselection mechanism such as MBS specific cell reselection, but may nevertheless enable the UE 400 to reselect to a cell which provides the service such as MBS in which the UE 400 is interested or wants to consume. On the other hand, by way of providing the NSSAI and cell reselection/NSAG priorities to the UE 400, the UE 400 may also be controlled to camp on or reselect to a cell which does not provide the service such as MBS, for any other reason, for example because there may be a still more important service provided in the cell not providing MBS. Thus, generally, this way of cell reselection configuration information provision makes the UE 400 to apply the slice specific cell reselection mechanism irrespective of any other possibly relevant or ongoing service transmission, so that the UE 400 prioritizes cells for cell reselection based on the NSSAI provided by the network.

Exemplarily, with reference to FIG. 7A, at 501, the UE 400 sends a Registration Request message to the network, e.g. in this example via a first cell 401 provided by a RAN element such as gNB, for a core network element such as the Access and Mobility Management Function (AMF) 500 of the wireless communication network. The Registration Request message may include requested NSSAI information of the UE 400, reflecting capabilities and services that the UE 400 is potentially going to use later on.

Next, at 502, the network includes S-NSSAI(s) e.g. related to ongoing MBS service as Allowed NSSAI (alternatively, as Configured NSSAI). This is based on the UE capability information indicating e.g. the UE 400 supports MBS. In other instances, Sidelink communication related S-NSSAIs and/or High-Speed Data Network (HSDN) related S-NSSAIs may be included based on the UE capability and UE's interest in those services. The information to be included by the network in a response to the Registration Request message such as a Request Accept message discussed below may be based, beyond UE capability information, on indications e.g. that the UE 400 is going to start a service such as Multicast Broadcast Service (MBS) and/or that there is an ongoing service transmission such as a broadcast session in the Tracking Area (TA) e.g., in Cell 402.

The network element such as the AMF 500 returns, at 503, a Registration Accept message via the first cell 401 to the UE 400. Accordingly, the UE 400 receives the Registration Accept message. As mentioned above, the Registration accept message carries the Allowed NSSAI including the MBS relevant S-NSSAI(s). Additionally, the AMF 500 may also send, at 504, Network Slice Access stratum Groups (NSAGs) and corresponding priorities via the first cell 401 to the UE 400. The NSAG is defined within a TA and identifies a set of slices and priorities in the TA.

The received information, the UE 400 is in the CONNECTED or ACTIVE state in the cell 401 (at 505) and may consume any service such as an IP call or any other data communication.

After a period of time, e.g., due to inactivity of the UE 400, end of service consumption or other network related reasons, the network may decide to change the status of the UE 400 to the RRC IDLE state. Thus, the network (e.g., cell1 401) may send, at 506, a RRC Release message to the UE 400 to transit the UE's status from the RRC connected state to the RRC IDLE state. In addition, the connection between the UE and the cell1 401 may be released.

Concurrently, the network may transmit, at 507, NSAG specific cell reselection priorities to provide the UE 400 with updated cell reselection configuration information facilitate cell reselection in RRC IDLE or RRC INACTIVE state. The NSAG specific cell reselection priorities may be signaled by way of broadcasting, e.g. in SIB16 (e.g., FreqPriorityListNRSlicing with Information element cellReselectionPriority or functionally similar information elements, cf. TS 38.331). Note that, in some embodiments, only NSAGs to specific frequencies mapping is signaled without any priority indications (no CellReselectionPriority Information Element).

In RRC IDLE or RRC INACTIVE state, the UE 400 generally performs cell reselection in accordance with the established procedures, i.e. measurement of radio conditions of the cell on which the UE 400 camps as well as neighboring cells. At some point of time, the UE 400 performs cell reselection, taking into account current radio conditions as well as other information set out above, including the S-NSSAI received at 503, the NSAGs with priorities received at 504 and/or the NSAG specific cell reselection priorities received at 507, in order to reselect to another second cell or, keep camping on the current first cell 401. In the examples of FIG. 7A and FIG. 7B, the UE applies the slice specific cell reselection mechanism at 508 in accordance with the S-NSSAI received at 503, the NSAGs with priorities received at 504 and the NSAG specific cell reselection priorities received at 508. The UE 400 will not modify reselection priorities due to other causes (e.g. MBS frequency prioritization) and other cell reselection mechanisms, even if the UE 400 has received cell reselection configuration information for such other cell reselection mechanisms and such other cell reselection mechanism triggers a cell reselection. Rather, the UE 400 performs cell reselection based on the unmodified reselection priorities and camps on or reselects to a cell based on the aforementioned information received at 503, 504 and/or 508. In the use cases of FIGS. 7A and 7B, the UE 400 does not need to consider such other cell reselection mechanisms as the slice-specific cell reselection configuration information of 502, 504 and/or 508 enables to the UE 400 to reselect to any cell which provides one or more relevant features for the UE 400 such as services like MBS sessions, HSDN transmissions and/or Sidelink communications.

In this respect, various situations may occur. For example, FIG. 7A shows a case in which the UE 400 has received a service announcement such as an MBS service announcement (not shown in FIG. 6) indicating that an MBS transmission is provided at the frequency of the second cell 402 (e.g., cell2), but not in the first cell 401 (e.g., cell1). However, the UE 400 does apply an MBS specific cell reselection mechanism, but utilizes the S-NSSAI received at 503, the NSAG received at 504 and the NSAG specific cell reselection priorities received at 508 instead. In the example of FIG. 7A, the S-NSSAI prioritizes the first cell 401 over the second cell 402, i.e. indicates to the UE 400 to remain in the first cell 401. Therefore, the UE 400 does not prioritize the frequency of second cell 402 as it would have been the case in the event of MBS specific cell reselection. Rather, the UE 400 uses slice-specific cell reselection and therefore does not reselect to the second cell 402, camps on the first cell 401 at 509.

Another case based on S-NSSAI, NSAG and NSAG specific cell reselection priority signaling is given by FIG. 7B, in which activities 501 to 508 correspond to those of FIG. 7A. However, here, the relevant S-NSSAI indicate to apply slice specific cell reselection and the NSAG and the NSAG specific cell reselection priorities to prioritize the second cell 402. This can be based on UE capabilities and information about a service supported by or going to be or currently provided in the second cell 402. For example, the network may be aware that the UE 400 is capable of MBS and that the second cell 402 supports MBS, or that an MBS session is currently broadcast in the second cell 402. Hence, the S-NSSAI provided at 503, the NSAG provided at 504 and the NSAG specific cell reselection priorities provided at 508 to the UE 400 may indicate a slice specific priority of second cell 402 compared to the first cell 401. Again, the UE 400 may have received an MBS service announcement at some point e.g. between activities 506 and 508 indicating that the MBS service is provided at frequency of the second cell 402, but not in the first cell 401. Again, the UE 400 does not prioritize the frequency of the second cell 402 due to an MBS specific cell reselection mechanism, but prioritizes the second cell 402 by applying, at 508, slice specific cell reselection. As a result, the UE 400 reselects to the second cell 402 based on slice-specific cell reselection mechanism and starts camping on the selected cell (e.g., the second cell), at 510.

After the successful reselection to the second cell 402, the UE 400 may receive, at 511, NSAG specific cell reselection priorities from the network via the second cell 402, e.g. by way of SIB16. Additionally, as the MBS session is not provided in the first cell 401, the network may include the frequency of the first cell 401 to an “Excluded List” for that S-NSSAI. According to the “Excluded List”, the UE 400 excludes the first cell 401 as a potential candidate for cell reselection and does not reselect to or camp on the first cell 401.

Hence, in the scenarios of FIGS. 7A and 7B, the network controls the UE 400 to apply slice specific cell reselection by providing slice-specific cell reselection configuration information to the UE 400 which may or may not prioritize cells offering services such as MBS, HSDN, Sidelink, and others for cell reselection purposes. Note that MBS is mentioned as the primary service or feature example in the examples of FIGS. 7A and 7B, but the skilled person will understand that this is of exemplary character only and may likewise apply to any other service with a corresponding cell reselection mechanism. The scenarios of FIGS. 7A and 7B can be summarized by that the UE 400 receives at least one Network Slice Access Stratum Group, NSAG, and priority information of the at least one NSAG. The UE 400 derives, based on the at least one NSAG and priority information of the at least one NSAG, a reselection priority of the slice-based cell reselection according to a predefined scheme, and the UE 400 does not to modify the reselection priority due to other causes for cell reselection, such as MBS-related cell reselection configuration information received by the UE 400. The priority information of the at least one NSAG comprises at least one of a priority per NSAG and one or more priorities for corresponding one or more frequencies mapped to the at least one NSAG, as explained above. Note that, second cell 402 may belong to the same gNB or CU controlling the first cell 401 or to the another gNB controlling first cell 401.

In some embodiments, now with reference to FIGS. 8A and 8B, the cell reselection configuration information is indicative of a priority order of a plurality of cell reselection mechanisms. More specifically, in exemplary embodiments according to FIGS. 8A and 8B, the cell reselection configuration information is indicative of a priority order of a plurality of cell reselection mechanisms includes a sorted list of at least two of the plurality of cell reselection mechanisms. The sorted list may indicate a relative priority among the at least two of the plurality of cell reselection mechanisms, e.g. the first-listed cell reselection mechanism has a highest priority, while the last-listed cell reselection mechanism has a lowest priority among the listed cell reselection mechanisms.

The scenarios of FIGS. 8A and 8B may incorporate a flow similar to activities 501 to 506, bringing the UE 400 eventually in RRC IDLE state or RRC INACTIVE state, at 600. Generally, and similar to FIGS. 7A and 7B, the UE 400 is assumed to support slice specific cell reselection, but the UE is also interested in receiving a service provided by one or more cells of the communication network, such as Sidelink/HSDN and broadcast services.

In embodiments according to FIGS. 8A and 8B, the network element providing the first cell 401 signals, at 601, a list of one or more features or, more generally, one or more cell reselection mechanisms, in a prioritized manner. This controls the UE to use the applicable cell reselection mechanism of the highest signaled priority when performing cell reselection. The one or more features and one or more corresponding cell reselection mechanisms, respectively, signaled to the UE 400 may take the form of a list. For example, if the list has been configured as {MBS, Sidelink, HSDN, Slice}, the list indicates that MBS specific cell reselection has the highest priority and slice specific cell reselection has the lowest priority. A UE 400 that has capability and interest in e.g., MBS services, then applies the MBS specific cell reselection mechanism when performing a cell reselection procedure. Another UE 400 having an interest in Sidelink communications, but not in MBS sessions, in turn prioritizes cells using the cell reselection mechanism defined for Sidelink. Generally, the UE 400 applies, at 602, the cell reselection mechanism according to the priority list received at 601.

This list of prioritized features or cell reselection mechanisms may be provided to the UE through an RRC Release message when UE is transiting from RRC CONNECTED to RRC IDLE state. Additionally or alternatively, the list may be broadcast by system information such as SIB16.

Similar to FIGS. 7A and 7B, several scenarios can be envisaged in embodiments according to FIGS. 8A and 8B. In the example of FIG. 8A, the list signaled at 601 may be configured as {Slice, Sidelink, HSDN, MBS}. Hence, the UE 400 may apply a slice specific cell reselection. Consequently, at 603, the UE 400 uses slice-specific cell reselection mechanism that, in turn, causes the UE to stay in the current first cell 401. Hence, as indicated by the arrow 603 in FIG. 8A, the UE 400 remains to camp on the first cell 401.

Another complementary scenario is depicted by FIG. 8B, in which the network signals a cell reselection mechanism priority list at 601 indicating {MBS, Sidelink, HSDN, Slice}. The UE 400 may have received an MBS service indication, at some point after 602, indicating that an MBS session is started in the second cell 402. The UE 400 being interested in the MBS session then prioritizes the MBS frequency based on the MBS specific cell reselection mechanism as the cell reselection mechanism priority list received at 601 attributes a higher priority to MBS than slice specific cell reselection. The UE 400 then applies the MBS specific cell reselection based on the list of 601 and then reselects, at 604, to the second cell 402 to join the MBS session.

Note that, second cell 402 may belong to the same gNB or CU controlling the first cell 401 or to the another gNB controlling first cell 401. As mentioned above, in embodiments, the aforementioned cell reselection mechanisms are applied when the UE is in RRC IDLE state. Alternatively or additionally, in embodiments, the aforementioned cell reselection mechanisms are applied when the UE is in RRC INACTIVE state.

From the perspective of a user equipment (UE), the present disclosure may also be characterized by the following points:

Point 1: A method for cell reselection, the method being performed by a user equipment, UE, communicatively coupled to a cell of a wireless communication network, the method comprising receiving, from a network element of the wireless communication network, cell reselection configuration information, wherein the cell reselection configuration information includes network slice selection assistance information, NSSAI, related to a service capability of the UE and to a service provided by the wireless communication network, or is indicative of a priority order of a plurality of cell reselection mechanisms; and applying a cell reselection mechanism of the plurality of cell reselection mechanisms, based on the NSSAI or the priorities of the plurality of cell reselection mechanisms.

Point 2: The method of point 1, wherein the plurality of cell reselection mechanisms includes one or more of slice specific cell reselection, Multicast Broadcast Services specific cell reselection, High-Speed Data Networks specific cell reselection and Sidelink communication specific cell reselection.

Point 3: The method of point 2, wherein the NSSAI indicates one or more cells which provide for Multicast Broadcast Services transmissions, High-Speed Data Networks transmission or Sidelink communications.

Point 4: The method of point 3, further comprising, at the UE, receiving, from the network element of the wireless communication network, the NSSAI indicating one or more cells which provide for Multicast Broadcast Services transmissions, High-Speed Data Networks transmission or Sidelink communications; receiving a service announcement indicating that a Multicast Broadcast Services transmission, a High-Speed Data Networks transmission or a Sidelink communication is provided in at least one of the one or more cells indicated by the NSSAI; applying, based on the NSSAI, the slice-specific cell reselection mechanism and reselecting to one of the at least one cells indicated by the NSSAI based on the slice-specific cell reselection mechanism.

Point 5: The method of point 2, wherein the NSSAI indicates one or more cells which do not provide for Multicast Broadcast Services transmissions, High-Speed Data Networks transmission or Sidelink communications.

Point 6: The method of point 5, further comprising, at the UE, receiving, from the network element of the wireless communication network, the NSSAI indicating one or more cells which do not provide for Multicast Broadcast Services transmissions, High-Speed Data Networks transmission or Sidelink communications; receiving a service announcement indicating that a Multicast Broadcast Services transmission, a High-Speed Data Networks transmission or a Sidelink communication is provided in at least one of the one or more cells indicated by the NSSAI; applying, based on the NSSAI, the slice-specific cell reselection mechanism and reselecting to one of the at least one cells indicated by the NSSAI based on the slice-specific cell reselection mechanism.

Point 7: The method of point 2, wherein the cell reselection configuration information being indicative of a priority order of a plurality of cell reselection mechanisms includes a sorted list of at least two of the plurality of cell reselection mechanisms, the sorted list indicating a relative priority among the at least two of the plurality of cell reselection mechanisms.

Point 8: The method of point 7, wherein the priority order indicates a priority of the slice-specific cell reselection mechanism over at least one other of the plurality of cell reselection mechanisms, the method further comprising, at the UE, receiving a service announcement indicating that a Multicast Broadcast Services transmission, a High-Speed Data Networks transmission or a Sidelink communication is provided in at least one cell of the wireless communication network; applying, based on the priority order, the slice-specific cell reselection mechanism.

Point 9: The method of point 7, wherein the priority order indicates a priority of a first of the plurality of cell reselection mechanisms over the slice-specific cell reselection mechanism, the method further comprising, at the UE, receiving a service announcement indicating that a service transmission corresponding to the first cell reselection mechanism is provided in one or more cells of the wireless communication network; applying, based on the priority order, the first cell reselection mechanism and reselecting to one of one or more cells of the wireless communication network to receive the service transmission.

Point 10: The method of point 7, wherein the priority order indicates a priority of a first one of the plurality of cell reselection mechanisms over a second one of the plurality of cell reselection mechanisms and, in turn, over the slice-specific cell reselection mechanism, the method further comprising, at the UE, receiving a service announcement indicating that a service transmission corresponding to the second cell reselection mechanism is provided in one or more cells of the wireless communication network; applying, based on the priority order, the second cell reselection mechanism and reselecting to one of the one or more cells of the wireless communication network to receive the service transmission.

Point 11: The method of any one of points 1 to 10, wherein the cell reselection configuration information is received through system information and/or dedicated signaling.

Point 12: The method of any one of points 1 to 11, wherein the cell reselection configuration information includes an allowed list of cells providing the service or an excluded list of cells not providing the service.

Point 13: The method of any one of points 1 to 12, wherein the UE is in IDLE state or in INACTIVE state when applying the cell reselection mechanism based on the cell reselection configuration information.

Point 14: The method of any one of points 1 to 13, comprising: receiving at least one Network Slice Access Stratum Group, NSAG, and priority information of the at least one NSAG; and deriving, based on the at least one NSAG and priority information of the at least one NSAG, a reselection priority of the slice-based cell reselection according to a predefined scheme, wherein the UE does not modify the reselection priority due to other causes for cell reselection.

The method of point 15, wherein the priority information of the at least one NSAG comprises at least one of a priority per NSAG and one or more priorities for corresponding one or more frequencies mapped to the at least one NSAG.

Corresponding points can be listed for the apparatus and user equipment category.

Corresponding points may be set forth specifying an apparatus such as a user equipment being arranged to perform these method points. For example, the apparatus may be equipped with a processor and memory storing program instructions which implemented the aforementioned UE-related method points when executed by the processor.

It should be understood that the apparatuses described herein may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5G NR, similar principles can be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes exemplary embodiments, there are several variations and modifications which may be made to the disclosed solution without departing from the scope of the subject disclosure.

In general, the various exemplary embodiments may be implemented in hardware or special purpose circuits, software, logic or any combination thereof. Some aspects of the subject disclosure may be implemented in hardware, while other aspects may be implemented in firmware or software which may be executed by a controller, microprocessor or other computing device, although the subject disclosure is not limited thereto. While various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the subject disclosure as defined in the appended claims. Indeed, there is a further embodiment comprising a combination of one or more embodiments with any of the other embodiments previously discussed.

1.-30. (canceled)

31. A user equipment, UE, communicatively coupled to a network element of a wireless communication network and comprising a processor and a memory with instructions which, when executed by the processor, cause the UE to:
receive, from the network element, cell reselection priorities corresponding to a determined priority order among one or more features related to cell reselection, wherein the cell reselection priorities include at least one of Network Slice Access Stratum Group, NSAG, priorities and slice-specific cell reselection priorities that are mapped to a respective corresponding NSAG, wherein each of the one or more features is provided by the wireless communication network and is related to at least one of a service capability of the UE and a service request of the UE; and
apply a slice-specific cell reselection mechanism based on the NSAG priorities or based on the slice-specific cell reselection priorities.

32. The UE of claim 31, further being caused to:
receive, from the network element, Allowed Network Slice Selection Assistance Information, Allowed NSSAI, comprising at least one Single-Network Slice Selection Assistance Information, S-NSSAI, associated to the one or more features for cell reselection.

33. The UE of claim 31, further being caused to:
receive, from the network element, Configured Network Slice Selection Assistance Information, Configured NSSAI, comprising at least one Single-Network Slice Selection Assistance Information, S-NSSAI, associated to the one or more features for cell reselection.

34. The UE of claim 31, wherein the one or more features include at least one of slice specific cell reselection, Multicast Broadcast Services, High-Speed Data Networks specific and Sidelink communication.

35. The UE of claim 31, being caused to receive cell reselection priorities by being caused to receive the cell reselection priorities by way of system information broadcast or dedicated signaling.

36. A method for a slice-based cell reselection executed by a user equipment (UE), the method comprising:
receiving, from a network element, cell reselection priorities corresponding to a determined priority order among one or more features related to cell reselection, wherein the cell reselection priorities include at least one of Network Slice Access Stratum Group, NSAG, priorities and slice-specific cell reselection priorities that are mapped to a respective corresponding NSAG, wherein each of the one or more features is provided by a wireless communication network and is related to at least one of a service capability of the UE and a service request of the UE; and
applying a slice-specific cell reselection mechanism based on the NSAG priorities or based on the slice-specific cell reselection priorities.

37. The method of claim 36, further comprising:
receiving, from the network element, Allowed Network Slice Selection Assistance Information, Allowed NSSAI, comprising at least one Single-Network Slice Selection Assistance Information, S-NSSAI, associated to the one or more features for cell reselection.

38. The method of claim 36, further comprising:
receiving, from the network element, Configured Network Slice Selection Assistance Information, Configured NSSAI, comprising at least one Single-Network Slice Selection Assistance Information, S-NSSAI, associated to the one or more features for cell reselection.

39. The method of claim 36, wherein the one or more features include at least one of slice specific cell reselection, Multicast Broadcast Services, High-Speed Data Networks specific and Sidelink communication.

40. The method of claim 36, further comprising:
receiving cell reselection priorities by being caused to receive the cell reselection priorities by way of system information broadcast or dedicated signaling.

41. A non-transitory computer readable medium storing instructions which, when executed by at least one processor, cause an apparatus to execute:
receiving, from a network element, cell reselection priorities corresponding to a determined priority order among one or more features related to cell reselection, wherein the cell reselection priorities include at least one of Network Slice Access Stratum Group, NSAG, priorities and slice-specific cell reselection priorities that are mapped to a respective corresponding NSAG, wherein each of the one or more features is provided by a wireless communication network and is related to at least one of a service capability of a user equipment (UE) and a service request of the UE; and
applying a slice-specific cell reselection mechanism based on the NSAG priorities or based on the slice-specific cell reselection priorities.

42. The non-transitory computer readable medium of claim 41, wherein the apparatus further caused to execute:
receiving, from the network element, Allowed Network Slice Selection Assistance Information, Allowed NSSAI, comprising at least one Single-Network Slice Selection Assistance Information, S-NSSAI, associated to the one or more features for cell reselection.

43. The non-transitory computer readable medium of claim 41, wherein the apparatus further caused to execute:
receiving, from the network element, Configured Network Slice Selection Assistance Information, Configured NSSAI, comprising at least one Single-Network Slice Selection Assistance Information, S-NSSAI, associated to the one or more features for cell reselection.

44. The non-transitory computer readable medium of claim 41, wherein the one or more features include at least one of slice specific cell reselection, Multicast Broadcast Services, High-Speed Data Networks specific and Sidelink communication.

45. The non-transitory computer readable medium of claim 41, wherein the apparatus further caused to execute:
receiving cell reselection priorities by being caused to receive the cell reselection priorities by way of system information broadcast or dedicated signaling.
